(19) United States
(12) Patent Application Publication
(10) Pub. No.: US 2009/0269552 A1
(43) Pub. Date: Oct. 29, 2009

(54) ARMOUR PLATE

(75) Inventor: Jacob FOLDAGER, Hobro (DK)

Correspondence Address: BANNER & WITCOFF, LTD., 1100 13th STREET, N.W., SUITE 1200, WASHINGTON, DC, 20005-4051, US

(73) Assignee: COMPOSHIELD A/S, Hobro (DK)

(21) Appl. No.: 12/418,306

(22) Filed: Apr. 3, 2009

Related U.S. Application Data
(63) Continuation of application No. 11/631,521, now abandoned.

(30) Foreign Application Priority Data
Jul. 6, 2004 (GB) 0415171.8
Jul. 16, 2004 (GB) 0416000.8
Jan. 1, 2005 (GB) 0501974.0
May 19, 2005 (GB) 0510228.0

(51) Int. Cl. B32B 3/06; B32B 15/08; B32B 27/06; B32B 17/10; B32B 27/00; B32B 15/14; B32B 5/28; D04H 13/00

(52) U.S. Cl. 428/172; 428/457; 428/688; 428/426; 428/500; 442/234; 442/239; 442/378; 442/392; 442/327

(57) ABSTRACT

Armour plate comprising a mass of cured resinous material having a face surface and a back surface, a tile layer comprising a single ceramic or metal tile, or a plurality of coplanar ceramic or metal tiles arranged in edge to edge relationship, entirely embedded in the resinous mass to a depth of at least 1 mm from the face surface, and a backing layer of impact resistant flexible material embedded or partially embedded in the resinous mass on the side of the tile(s) towards the back surface.

### CROSS REFERENCE TO RELATED APPLICATIONS

This application is a continuation of Ser. No. 11/631,521 filed Jan. 4, 2007 which claims benefit of PCT application PCT/EP2005/007010 filed Jun. 28, 2005, which claims the benefit of Great Britain application number 0415171.8 filed Jul. 6, 2004, Great Britain application 0416000.8 filed Jul. 16, 2004, Great Britain application 0501974.0 filed Jan. 1, 2005 and Great Britain application 0510228.0 filed May 19, 2005. These applications are incorporated herein by reference in their entireties.

### FIELD OF THE INVENTION

This invention relates to armour plate comprising a resin mass with embedded tile, and impact resistant backing layers.

### BACKGROUND OF THE INVENTION

A known type of armour plate for the protection of vehicles, for example, consists of a plurality of small ceramic tiles, arranged in edge-to-edge relationship, and adhered to a flexible backing layer or multilayer of impact resistant material such as woven aramid, glass, polyethylene, aluminium or steel filaments, whole being embedded in a cured resin mass such that the tile layer is presented as an exposed facing surface of the armour plate. However, when struck by a projectile, surface exposed tiles can suffer severe damage, and are often dislodged or fragmented, leaving the armour severely weakened. Indeed it is to minimise this damage that a plurality of small tiles are used rather than one larger tile. Dislodging or fragmenting one of many small tiles through impact leaves a smaller area of damage on the armour plate than would be the case if a single larger tile had been struck.

### SUMMARY OF THE INVENTION

The present invention provides an improved resinous armour plate which reduces the above problem. It also allows the use of a single tile per plate rather than a more expensive multiple tile arrangement.

According to the invention, there is provided armour plate comprising a mass of cured resinous material having a face surface and a back surface, a tile layer comprising a single ceramic or metal tile, or a plurality of coplanar ceramic or metal tiles arranged in edge to edge relationship, entirely embedded in the resinous mass to a depth of at least 1 mm from the face surface, and a backing layer of impact resistant flexible material embedded or partially embedded in the resinous mass on the side of the tile(s) towards the back surface.

### BRIEF DESCRIPTION OF THE DRAWINGS

FIG. 1 shows a cross-section of an armour plate in accordance with an aspect of the invention.

FIG. 2 shows a cross-section of an armour plate of FIG. 1 with reinforcing strips.

FIG. 3 shows a cross-section of an armour plate in accordance with another aspect of the invention

### DETAILED DESCRIPTION

The resinous mass can be any of those resin materials used or proposed for use in armour plate in the past. In particular resinous matrix material may be cured epoxy or polyurethane resin.

Likewise the backing layer can be any of those used or proposed for use in armour plate in the past. In particular the backing layer may comprise a plurality of layers of woven aramid, glass, polyethylene, aluminium or steel filaments. Preferably the backing layer is entirely embedded in the resinous mass, but embodiments where the backing layer is partially exposed on the back face of the plate may also be used. The tile(s) may be ceramic or metal, for example hardened steel such as that available under the trade names Hardox 600 or Armox 600, or of softer materials such as a high strength steel with a hard coating such as a chromium surface of thickness about 20 to 500 [mu]m.

Because the tile layer is embedded to a depth of at least 1 mm the tile(s) are not surface-exposed as in the known armour plate. Hence, on being struck by a projectile, the facing layer of resin tends to hold the tiles in place, rather than being lost or fragmented as in the past. Hence the damaged tiles remain functional to a useful extent. In practice it will be desirable to embed the tile layer in the resinous mass to a depth of from 1 to 8 mm, for example from 1 to 3 or from 3 to 8 mm, from the face surface.

Before incorporation in the resin mass, the tile(s) of the tile layer may be coated or partially coated with a primer coating which improves the bond between the resinous mass and the tile(s). Suitable primer coatings include epoxy- and polyurethane-based paints.

The armour plate of the invention may include, in addition to the backing layer, a facing layer of impact resistant flexible material embedded or partially embedded in the resinous mass on the side of the tile(s) towards the face surface. Like the backing layer, the facing layer may also may comprise one or a plurality of layers of woven aramid, glass, polyethylene, aluminium or steel filaments. Preferably the facing layer is entirely embedded in the resinous mass, but embodiments where it is partially exposed on the face surface of the plate may also be used.

The edges of the armour plate of the invention may be reinforced by embedding strips of flexible reinforcement material in the resin mass around the periphery of the plate. Thus, strips of, for example, glass-, carbon-ir aramid fibre may be embedded in the resin along each edge, each strip overlapping the face and back surfaces. Such strips can be beneficial in improving the integrity of the panel when the panel is hit by a projectile close to an edge.

In the preparation of the armour plate, the tile and backing layers, and edge reinforcement strips if present, are simply immersed in the uncured resin in a suitable mould, and cured or allowed to cure. The tile and backing layers may be immersed separately, or the tile layer may be adhered to the backing layer and the composite layer then immersed. For some applications there may be advantages in spacing the tile(s) from the backing layer to provide an intermediate resin layer for so-called “soft impact” effects. When the tile and backing layers abut each other, so-called “hard impact” effects may be obtained.

In one preferred embodiment of the invention, the armour plate comprises two backing layers of impact resistant flexible material, the first embedded in the resin mass adjacent the back surface of the tile layer, the second embedded or partially embedded in the resin mass adjacent the back surface of the plate; and clamping means entirely embedded in the resin mass, exerting clamping force between the face surface of tile layer and the back face of the first backing layer to restrain separation of the tile layer and first backing layer at their interface. The clamping means may be, for example, a plurality of nut and bolt devices passing through the tile layer to the back face of the first backing layer.

Armour plates in accordance with the invention will often be provided with holes adapted to receive bolts for fixing the armour plate to the object, often a vehicle, which it is to protect. Thus, the plate may have a plurality of passages, arranged around the periphery of the plate, for example one at each corner of a square plate, passing through the plate and fitted with bush elements in their face and back surface openings, for receiving bolts for facilitating mounting of the plate on a surface or framework. To deflect projectiles, the bolts may have conical heads.

The resinous mass may be impregnated with dye or pigment, either throughout the entire mass, or at least between the front surface and the tile(s). Sufficient dye or pigment may be incorporated to render the resinous mass opaque, at least between the front surface and the tile(s), such that the tile(s) is/are invisible or poorly visible from the front surface side of the plate. Such embodiments can be advantageous, in that if the surface of the armour plate is scuffed or suffers other damage short of the projectile or blast damage which it is intended to resist, the normal, highly visible, white or shiny surface of the ceramic or metal tile remains obscured, thereby minimising the risk of unintended loss of camouflage or other low visibility advantage.

A further advantage of armour plate according to the invention is its modularity. The level of armour protection available may be increased by the simple expedient of superimposing individual plates. In such cases, the plates may be directly superimposed, with or without adhesive binding, or they may be indirectly superimposed with interposed materials such as impact resistant flexible materials or thermal or sound insulation materials. In cases where the armour plates are provided with bolt holes for fixing to the object to be protected, the fixing bolts can simply pass through the two or more superimposed plates. The term “superimposed” is used herein to include both direct contact and indirect superimposition of the kinds described above. This modularity avoids the need to manufacture individual plates of varying performance grades.

One embodiment of the invention will now be described by reference to Fig !, which shows a cross section of an armour plate in accordance with the invention. The plate may have the desired shape and overall dimensions dictated by the intended use. In the present case, the plate 1 is 1000 mm square by 25 mm in thickness. A planar array 2 of ceramic tiles 2 arranged edge to edge, each 50 mm square by 16 mm in thickness, is entirely embedded in resin mass 3 to a depth of 3 mm below the face surface 4 of the plate. A multilayer aramid backing layer 5 is embedded in the resin mass below the tile array 2, towards the back face 6 of the plate. In this case, the backing layer is not pre-bonded to the tiles but rather is separated from the tiles by a resin layer, and it is partially exposed on the back face of the plate.

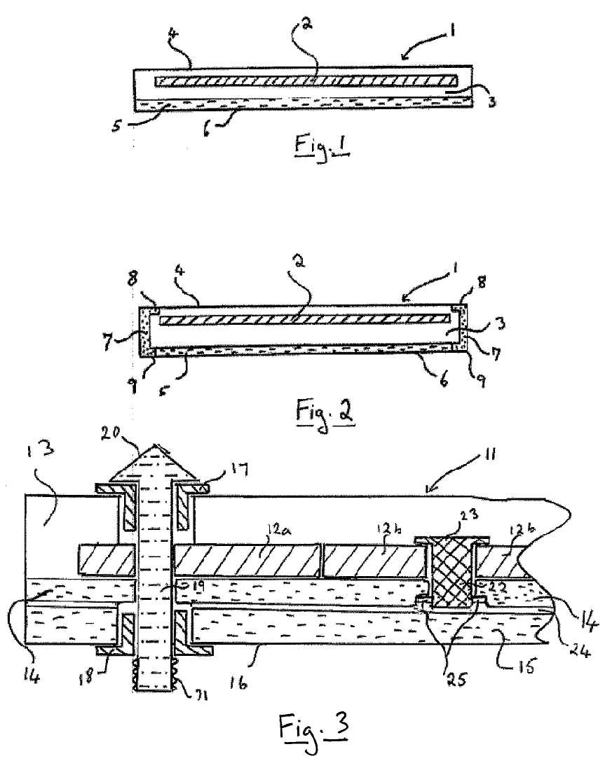

In FIG. 2, the armour plate of FIG. 1 is shown, again in cross section, with reinforcing strips 7 of multiplayer aramid fibre embedded in the resin mass around the edges of the plate. The strips overlap the face surface 4 by about 10-50 mm at 8, and overlap the back surface by a similar amount at 9.

Further features which may be present in armour plate of the invention are illustrated with reference to FIG. 3, which shows a cross section of part of another armour plate 11 in accordance with the invention. Again a planar array of ceramic tiles is arranged edge to edge, two tiles being indicated at 12a and 12b, and is entirely embedded in a resin mass 13. Again a multilayer aramid backing layer 15 is embedded in the resin mass below but spaced away from the tile array, towards the back face 16 of the plate. In this embodiment a second aramid backing layer 14 is embedded in the resin mass in contact with, and usually glued to, the back face of the tile array. The two backing layers 15 and 14 may be in contact or, as in this case, separated by a thin layer 24 of the resin mass 13.

At each corner of the plate, a passage is formed through the resin mass, the tile array and the two backing layers 14 and 15. One such passage is shown in FIG. 3, with bushes 17 and 18 friction fitted into the passage openings on the face and back surfaces respectively of the plate. A bolt 19 passes snugly through bushes with its conical head 20 on the face surface of the plate and its threaded end 21 projecting from the back of the plate. These bolts provide means for mounting the plate on a surface or framework by passing the threaded projecting end through a corresponding hole in the surface or framework, and threading a nut onto the bolt to hold the plate in place. The advantage of the bushing-bolt mounting system is twofold: Firstly it squeezes the panel together via the bushes and thereby improves the multi-hit capability and secondly the conical shape of the bolt head tends to deflect and reduce the risk of penetration of projectiles at the mounting points

When armour plates with one backing layer as in FIGS. 1 and 2 are subjected to impact from high calibre weapons (for example >12.7 mm) there is a risk of delamination between tile layer and backing layer due to the large transverse forces. Such delamination decreases multi-hit capability rapidly because there is no contact and structural bond between the tiles and the backing layer. The embodiment of FIG. 3, reduces this risk, by clamping the face surface of the tile layer to the back surface of the additional backing layer 14 by means of a plurality of bolts, one bolt per tile, in several of the tiles of the array. One such bolt 22 is shown in FIG. 3, with a flat head 23, passing through a passage formed in one of the tiles of the array and the additional backing layer 14. A threaded nut or washer 25 is screwed onto the bolt 22 to abut and compress the backing layer 14, thereby clamping the backing layer 14 to the tile array. The head of the bolt and the threaded nut or washer may be countersunk into the face of the tile. Usually the head of the bolt will be glued to the tile face or countersink, the backing layer will be glued to the back of the tile array, and the nuts 25 tightened on the bolts 23, prior to immersion of the resultant tile array/bolted backing layer 14 in uncured resin. With the arrangement shown in FIG. 3, if the reinforcement bolt is hit directly, the backing layers 14 and 15 prevent the bolt from being pushed through the back face of the plate to become a projectile itself. Delamination of the tile array from the additional backing layer 14 under projectile impact is resisted by the glue bond between the tile array and the backing layer 14 by the bush/bolt 17, 18, 19 arrangement described above. Furthermore, if such delamination does occur, the main backing layer 15 lends additional integrity to the assembly.

1. Armour plate comprising
a mass of cured resinous material having a face surface and a back surface,
a tile layer comprising a single ceramic or metal tile, or a plurality of coplanar ceramic or metal tiles arranged in edge to edge relationship, entirely embedded in the resinous mass to a depth of at least 1 mm from the face surface, and
a backing layer of impact resistant flexible material embedded or partially embedded in the resinous mass on the side of the tile(s) towards the back surface.

2. Armour plate as claimed in claim 1 wherein the backing layer comprises a plurality of layers of woven aramid, glass, polyethylene, aluminium or steel filaments.

3. Armour plate as claimed in any of the preceding claims wherein the backing layer is entirely embedded in the resinous mass.

4. Armour plate as claimed in any of the preceding claims wherein the tile layer is embedded in the resinous mass to a depth of from 1 to 8 mm from the face surface.

5. Armour plate as claimed in any of the preceding claims wherein flexible reinforcement material is embedded in the resin mass around the periphery of the plate, overlapping the face and back surfaces.

6. Armour plate as claimed in claim 6 wherein the flexible reinforcement material layer comprises one or more woven or non-woven layers of aramid, glass, polyethylene, aluminium or steel filaments.

7. Armour plate as claimed in any of the preceding claims comprising two backing layers of impact resistant flexible material, the first embedded in the resin mass adjacent the back surface of the tile layer, the second embedded or partially embedded in the resin mass adjacent the back surface of the plate; and clamping means entirely embedded in the resin mass, exerting clamping force between the face surface of tile layer and the back face of the first backing layer to restrain separation of the tile layer and first backing layer at their interface

8. Armour plate as claimed in claim 7 wherein the clamping means comprises a plurality of nut and bolt devices passing through the tile layer to the back face of the first backing layer.

9. Armour plate as claimed in any of the preceding claims which has a plurality of passages, passing through the plate and being fitted with bush elements in their face and back surface openings, for receiving bolts for facilitating mounting of the plate on a surface or framework.

10. Armour plate as claimed in claim 9 wherein the bolts for facilitating mounting of the plate have conical heads.

11. Armour plate as claimed in any of the preceding claims wherein the resinous mass is impregnated with dye or pigment at least between the front surface and the tile(s).

12. Armour plate as claimed in claim 8 wherein the dye or pigment renders the resinous mass opaque, at least between the front surface and the tile(s), such that the tile(s) is/are not visible from the front surface side of the mass.

13. Armour plate comprising two or more superimposed armour plates as claimed in any of the preceding claims.
